(19) United States
(12) Patent Application Publication
(10) Pub. No.: US 2015/0173413 A1
(43) Pub. Date: Jun. 25, 2015

(54) FOOD AND BEVERAGE APPARATUS

(71) Applicant: Watson Enterprises Incorporated, New Canaan, CT (US)

(72) Inventors: Jason Wells, Naugatuck, CT (US); Kiana Lynn Machnicz, Naugatuck, CT (US)

(21) Appl. No.: 14/575,193

(22) Filed: Dec. 18, 2014

Related U.S. Application Data
(60) Provisional application No. 61/919,389, filed on Dec. 20, 2013.

(51) Int. Cl. A23P 1/08; B65D 25/28; B65D 25/10; A47G 19/22

(52) U.S. Cl. CPC A23P 1/084; A47G 19/2205; B65D 25/2805; B65D 25/10; A47G 2200/10; B65D 2525/285

(57) ABSTRACT

A drinking device comprising cup having a continuous side wall with an inner surface and an outer surface, and a bottom surface. The device also includes a basket comprising a magnetic first end and a second end; and a handle comprising a magnetic tab, wherein the magnetic tab of the handle is magnetically attracted to the magnetic first end of the basket through the side wall of the cup.

### CROSS-REFERENCE TO RELATED APPLICATION(S)

This application claims the benefit of priority to U.S. Prov. App. No., 61/919,389, titled Device movable by magnetic attraction, used for submerging or raising food items(s), into or out of a liquid inside of a drinking apparatus; filed Dec. 20, 2013; the entire contents of which are incorporated by reference.

### BACKGROUND

A popular way of enjoying cookies, pastries or other food objects is to dip, dunk or otherwise submerge the food object, at least partially, into a liquid or beverage. Common examples include dipping cookies into milk, biscotti or donuts into coffee, and bread into a cup of soup. Though enjoyable, dipping food items into a beverage can result in the food item, or parts of it, falling into the beverage. And dipping the food item required handling the food and the mug. An apparatus to allow dipping of food items into a liquid without directly handling the food item and preventing the food item from breaking into the beverage is desirable.

### SUMMARY

This specification describes an apparatus and method for dipping or at least partially submerging a food item into a liquid or beverage.

In an example embodiment of the present invention an apparatus for dipping a food item into a liquid comprises a basket comprising a magnetic first end and a second end; and a handle comprising a magnetic tab; wherein the magnetic tab of the handle is magnetically attracted to the magnetic first end of the basket and wherein the handle is removable from the basket.

Still other example embodiments of the present invention may include one or more of the following features. The basket comprises at least two side walls. The basket comprises at least one side wall and a bottom surface. The bottom surface of the basket comprises at least one drain hole. The basket comprises a food grade material and the magnetic first end comprises a magnet at least partially encased in a food grade material. The basket comprises polycarbonate plastic and the magnetic first end comprises a magnet and a polycarbonate magnet casement wherein the polycarbonate magnet casement is bonded to the basket. The polycarbonate magnet casement is bonded to the basket by chemical adhesion, heat welding, ultrasonic adhesion, or mechanical connection. The first magnetic end and the handle each comprise polar oppositely arranged magnets comprising neo-dynium magnetic material, rare-earth magnetic material, ferrous magnetic material, or synthetic magnetic material. Either the first magnetic end of the basket or the magnetic tab of the handle comprises a magnet and the remaining component comprises a magnetically attractive material. The basket and the handle are configured to be magnetically attracted to each other through a separating medium including plastic, ceramic, glass, paper, wood, or non-ferrous metal.

In a further example of the present invention a drinking device comprises: a cup further comprising; a continuous side wall having an inner surface and an outer surface; and a bottom surface. The drinking device further comprises a basket comprising a magnetic first end and a second end; and a handle comprising a magnetic tab; wherein the magnetic tab of the handle is magnetically attracted to the magnetic first end of the basket through the side wall of the cup.

Various implementations of the present invention may also include one or more of the following features. The drinking device further comprises a cup having an inner vertical groove positioned on the inner surface of the side wall of the cup, wherein the magnetic first end of the basket is configured to slide along the inner vertical groove. The cup may further comprise an outer vertical groove positioned on the outer surface of the side wall of the cup, wherein the magnetic tab of the handle configured to slide along the outer vertical groove. A first magnet associated with the bottom surface of the cup and a second magnet associated with the basket, wherein the second magnet is repelled from the first magnet. The basket is positively buoyant. The basket is buoyant when containing a food item. The magnetic first end of the basket and the magnetic tab of the handle each contain magnets arranged with opposite polar charges, wherein the magnets are enclosed in a polycarbonate casement that is bonded to the body of the basket and handle. The inner vertical groove provides an thinner side wall of the cup compared to the remaining portions of the side wall. A vertical row of magnets is incorporated into the side wall of the cup.

Yet another implementation of the present invention provides a method of at least partially submerging a food item into a liquid comprising the steps of: providing a container for a liquid, the container comprising: a continuous side wall having an inner surface and an outer surface defining a wall thickness; a bottom surface; and a vertical groove in the side wall wherein the wall thickness at the vertical groove is thinner than at the remaining portions of the side wall; providing a basket comprising at least two side walls attached to a basket floor, the basket floor having at least one drain hole; and a polycarbonate casement enclosing a first magnet, the casement bonded to the basket, wherein the casement is configured to moveably fit within the vertical groove; a handle comprising a second casement enclosing a second magnet that is attracted to the first magnet, the second casement is bonded to the handle; then placing the basket within the container so that the polycarbonate casement is at least partially within the vertical groove; placing the handle on the outside surface of the container opposite the vertical groove such that the magnet in the basket and the magnet in the handle are attracted to one another; and moving the handle in an up or down motion to raise or lower the basket by magnetic attraction between the handle and the basket through the side wall.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a perspective view of an example embodiment of the present invention.

FIG. 1A is a right side view of an example embodiment of the present invention.

FIG. 2 is a front view of an example implementation of the present invention.

FIG. 3 is a back view of an example implementation of the present invention.

FIG. 4 is a top view of an example implementation of the present invention.

FIG. 5 is a bottom view of an example implementation of the present invention.

FIG. 6 is a right side view of an example implementation of the present invention.

FIG. 7 is a left side view of an example implementation of the present invention.

Like reference numbers and designations in the various drawings indicate like elements.

### DETAILED DESCRIPTION

Broadly, an example embodiment of the invention includes a container for a liquid, such as a cup or mug, a basket having a magnetic end, and a handle having a magnetic tab, wherein the basket is magnetically attracted to the handle through the side wall of the cup or mug and is movable using magnetic attraction by sliding the handle in an up or down motion, thereby lowering and raising the basket with the cup.

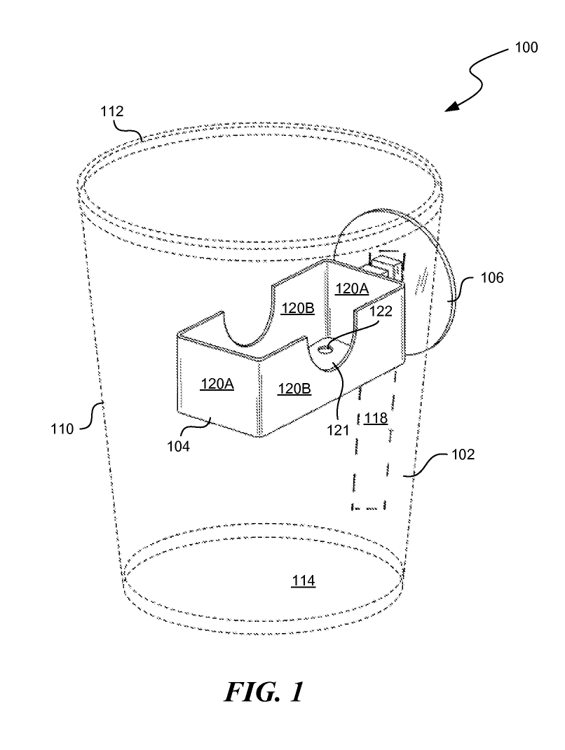

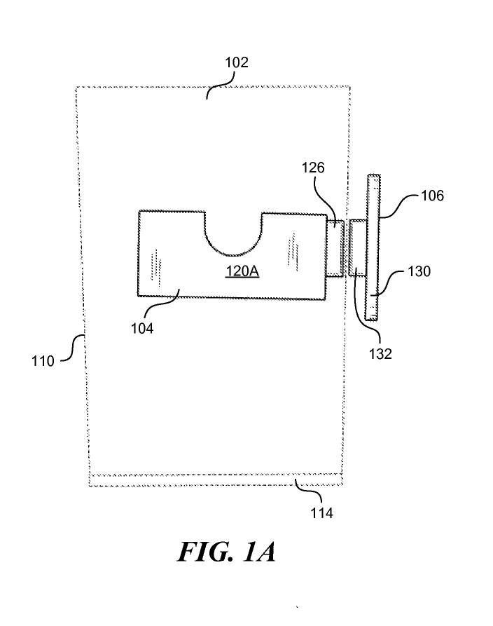

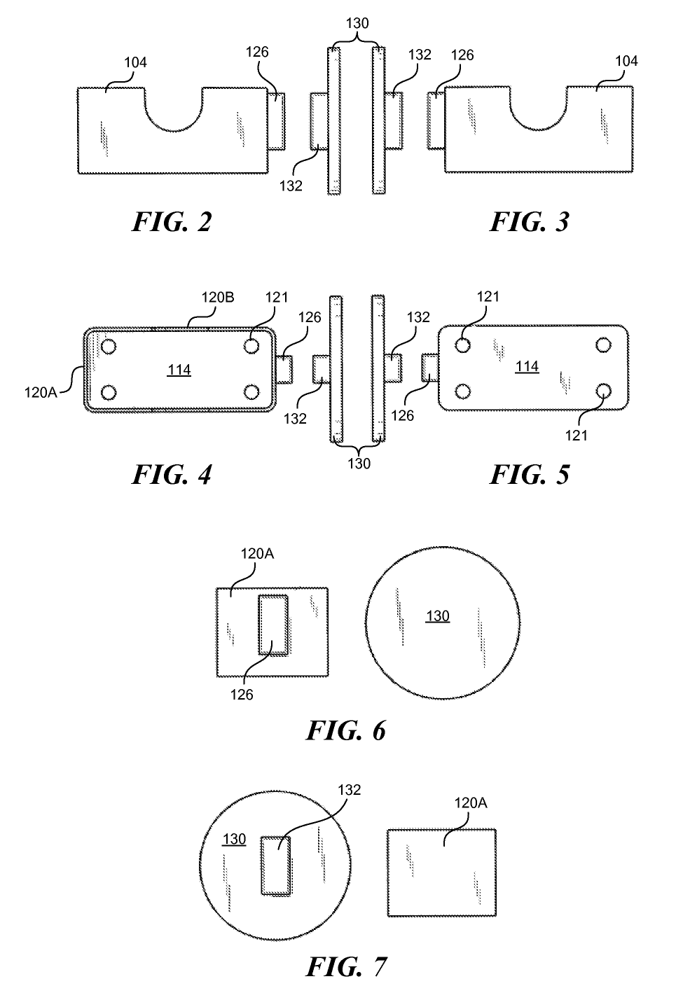

With reference to FIGS. 1 and 1A, a system 100 for dipping a food item in a liquid includes a container 102 for holding for a liquid. Container 102 may be, for example, a cup or mug. The dipping system also includes a basket 104 positioned with the container 102 and a handle 106, positioned opposite the basket and on the outside of the container. In operation the basket 104 is magnetically attracted to the handle 106 using a pair of magnets such that when the handle 106 is lowered down the side of the container 102 the basket 106 is likewise lowered into the container.

Container 102 can be any container suitable for holding a hot or cold liquid. For example container 102 can be a cup, mug, glass, bowl, etc. Container 102 includes a continuous side wall 110 having in inner surface and outer surface defining a sidewall thickness. The continuous side wall 110 can be cylindrical, oblong, angular or irregular in shape. Container 102 includes an upper lip 112 at the upper region of continuous side wall 110. Container 102 includes a bottom surface 114 that connects with the lower region of the continuous side wall 110.

In some embodiments container 102 includes a vertical groove 118 in side wall 110. Vertical groove 118 can be on the inner surface of side wall 110 or the outer surface of side wall 110. In some embodiments vertical groove 118 provides an area of side wall 110 having a wall thickness that is relatively thinner than the side wall thickness of the remaining portions of continuous side wall 110.

In still further embodiments container 102 may include a vertical series of two or more magnets embedded within the sidewall 110. Container 102 may also include a magnet associated with, attached to, or embedded in the bottom surface 114.

Container 102 can be made from plastic, polycarbonate plastic, other food grade plastics or polymers, ceramic, glass, wood, paper, or metal, or a combination of these materials.

In an example embodiment basket 104 includes a magnetic portion and a non-magnetic portion. As depicted in the various figures, basket 104 includes sidewalls 120A and 120B, as well as basket bottom piece 121. Various embodiments of the basket 104 include one, two, three or four sidewalls 120A and 120B. In some embodiment the side walls of the basket form substantially a parallelogram, within which a food item is placed. In other embodiments the basket may comprise one side wall for insertion into a food item. Another embodiment may include two substantially parallel side wall or two V-shaped side walls to form a tong or fork to hold a food item. Other arrangements of the basket sidewalls are contemplated. The basket sidewalls may include an upper region that is more buoyant that the remaining regions of the side wall to provide more buoyancy than the basket would ordinarily provide due to its shape and material properties. For example, a buoyant, food grade foam or tube may be included around all or parts of the basket to provide enough buoyancy to ensure the basket floats when loaded with a food item.

In some example embodiments the basket portion 104 does not include a bottom piece 121. In other example embodiments bottom piece 121 of basket 104 is substantially solid. Or bottom piece 121 can include one or more drain holes 122. Bottom piece 122 can be made of a porous construction. Bottom piece 122 can provide buoyance to the basket 104 so that basket 104 floats when not attached to the sidewall of the container 102. In some embodiments the bottom piece 121 may include a magnet within, on top of, or underneath the bottom surface.

Basket 104 can be made from plastic, polycarbonate plastic, other food grade plastics or polymers, ceramic, glass, wood, paper, or metal, or a combination of these materials.

Basket 104 may also include a casement 126 attached to one of the side walls. Casement 126 contains a magnet 127 and ensures that such magnet 127 cannot become detached or otherwise separated from the basket side wall. Casement 126 can be chemically adhered to, heat bonded to, or ultrasonically welded to the basket side wall. Casement 126 can be mechanically attached to the side wall of the basket. Casement 126 encloses a magnet. In some embodiments the magnet is neo-dynium magnetic material, rare-earth magnetic material, ferrous magnetic material, or synthetic magnetic material. In an example embodiment the magnet is size N46 through N54 (e.g., N46, N48, N50, N52 or N54).

In some example embodiments the magnet and casement 126 are sized and shaped to fit with substantially continuous contact with the inner surface of the container side wall 112. In other example embodiments the casement 126 is configured and sized to fit at least partially within the vertical groove 118.

Embodiments of the present invention also include handle 106 which comprises a handle grip 130 and a handle magnet casement 132. Handle 106 can be made from plastic, polycarbonate plastic, other food grade plastics or polymers, ceramic, glass, wood, paper, or metal, or a combination of these materials. Handle magnet casement 132 is attached to handle grip 130. Handle magnet casement 132 contains a magnet 133 and ensures that such magnet 133 cannot become detached or otherwise separated from the handle 130. Handle magnet casement 132 can be chemically adhered to, heat bonded to, or ultrasonically welded to the handle grip 130. Handle magnet casement 132 can be mechanically attached to the handle grip 130. Handle magnet casement 132 encloses a magnet 133. In some embodiments the magnet 133 is neo-dynium magnetic material, rare-earth magnetic material, ferrous magnetic material, or synthetic magnetic material. In an example embodiment the magnet 133 is size N46 through N54 (e.g., N46, N48, N50, N52 or N54).

In some example embodiments the magnet 133 and handle magnet casement 132 are sized and shaped to fit with substantially continuous contact with the outer surface of the container side wall 112. In other example embodiments the handle magnet casement 132 is configured and sized to fit at least partially within the vertical groove 118 when such vertical groove 118 is on the outer surface of the container sidewall 112.

In other example embodiments, the handle casement 132 may include a magnet as described above while the basket casement 126 includes a magnetically attractive material. In still another example embodiment the basket casement may include a magnet as described above while the handle casement 132 includes a magnetically attractive material. For example, the handle may include a magnet and the basket may include a ferrous material attracted to the magnet.

It will be appreciated that in embodiments in which the basket casement 126 and the handle casement 132 both include a magnet, the magnets are arranged respectively to attract one another due to the relative polarity of the magnets and not repel each other. In this manner the basket is held to the side wall of the container by magnetic attraction to the handle.

In some embodiments a magnet is placed on top of, underneath or embedded in the material of bottom surface 114 of the container. Similarly a magnet is placed underneath, on top of, or within the material of the basket bottom piece 121. In this example arrangement the magnet associate with the bottom surface of the container 114 and the magnet associated with the lower surface 121 of the basket are arranged such that the relative polarity of the two magnets repel each other. Such magnetic repulsion may give the basket the appearance of levitation from the bottom surface of the container.

The various embodiments of the invention may be used in method to at least partially submerging a food item into a liquid. First a container is provided wherein the container a continuous side wall with an inner surface and an outer surface defining a wall thickness, and a container bottom surface. The container may further have a vertical groove in the side wall wherein the wall thickness at the vertical groove is thinner than at the remaining portions of the side wall.

A basket is also provided wherein the basket includes at least two side walls attached to a basket floor, the basket floor has at least one drain hole. The basket also includes a polycarbonate casement enclosing a first magnet, the casement is bonded to the basket. The casement is configured to moveably fit within the vertical groove.

A handle is also provided, wherein the handle includes a second casement enclosing a second magnet that is attracted to the first magnet, the second casement is bonded to the handle.

The basket is placed within the container so that the polycarbonate casement is at least partially within the vertical groove.

The handle is placed on the outside surface of the container opposite the vertical groove such that the magnet in the basket and the magnet in the handle are attracted to one another.

The basket is lowered into the container by moving the handle in a downward direction along the outer surface of the container.

Other embodiments, variations and implementations of the present invention are contemplated and within the scope of the claims.

I/we claim:

1. An apparatus for dipping a food item into a liquid comprising
a basket comprising a magnetic first end and a second end; and
a handle comprising a magnetic tab;
wherein the magnetic tab of the handle is magnetically attracted to the magnetic first end of the basket and wherein the handle is removable from the basket.

2. The apparatus of claim 1 wherein the basket comprises at least two side walls.

3. The apparatus of claim 1 where in the basket comprises at least one side wall and a bottom surface.

4. The apparatus of claim 3 wherein the bottom surface comprises at least one drain hole.

5. The apparatus of claim 1 wherein the basket comprises a food grade material and the magnetic first end comprises a magnet at least partially encased in a food grade material.

6. The apparatus of claim 1 wherein the basket comprises polycarbonate plastic and the magnetic first end comprises a magnet and a polycarbonate magnet casement wherein the polycarbonate magnet casement is bonded to the basket.

7. The apparatus of claim 6 wherein the polycarbonate magnet casement is bonded to the basket by chemical adhesion, heat welding, ultrasonic adhesion, or mechanical connection.

8. The apparatus of claim 1 wherein the first magnetic end and the handle each comprise polar oppositely arranged magnets comprising neo-dynium magnetic material, rare-earth magnetic material, ferrous magnetic material, or synthetic magnetic material.

9. The apparatus of claim 1 wherein the either the first magnetic end of the basket or the magnetic tab of the handle comprises a magnet and the remaining component comprises a magnetically attractive material.

10. The apparatus of claim 1 where in the basket and the handle are configured to be magnetically attracted to each other through a separating medium including plastic, ceramic, glass, paper, wood, or non-ferrous metal.

11. A drinking device comprising:
a cup further comprising;
a continuous side wall having an inner surface and an outer surface; and
a bottom surface;
a basket comprising a magnetic first end and a second end; and
a handle comprising a magnetic tab;
wherein the magnetic tab of the handle is magnetically attracted to the magnetic first end of the basket through the side wall of the cup.

12. The drinking device of claim 11 further comprising an inner vertical groove positioned on the inner surface of the side wall of the cup, wherein the magnetic first end of the basket is configured to slide along the inner vertical groove.

13. The drinking device of claim 11 further comprising an outer vertical groove positioned on the outer surface of the side wall of the cup, wherein the magnetic tab of the handle configured to slide along the outer vertical groove.

14. The drinking device of claim 11 further comprising a first magnet associated with the bottom surface of the cup and a second magnet associated with the basket, wherein the second magnet is repelled from the first magnet.

15. The drinking device of claim 11 wherein the basket is positively buoyant.

16. The drinking device of claim 15 wherein the basket is buoyant when containing a food item.

17. The drinking device of claim 11 wherein the magnetic first end of the basket and the magnetic tab of the handle each contain magnets arranged with opposite polar charges, wherein the magnets are enclosed in a polycarbonate casement that is bonded to the body of the basket and handle.

18. The drinking device of claim 12 wherein the inner vertical groove provides an thinner side wall of the cup compared to the remaining portions of the side wall.

19. The drinking device of claim 11 wherein a vertical row of magnets is incorporated into the side wall of the cup.

20. A method of at least partially submerging a food item into a liquid comprising the steps of:
providing a container for a liquid, the container comprising:
a continuous side wall having an inner surface and an outer surface defining a wall thickness;
a bottom surface; and
a vertical groove in the side wall wherein the wall thickness at the vertical groove is thinner than at the remaining portions of the side wall;
providing a basket comprising;
at least two side walls attached to a basket floor, the basket floor having at least one drain hole; and
a polycarbonate casement enclosing a first magnet, the casement bonded to the basket, wherein the casement is configured to moveably fit within the vertical groove;
a handle comprising a second casement enclosing a second magnet that is attracted to the first magnet, the second casement is bonded to the handle;
placing the basket within the container so that the polycarbonate casement is at least partially within the vertical groove;
placing the handle on the outside surface of the container opposite the vertical groove such that the magnet in the basket and the magnet in the handle are attracted to one another;
moving the handle in an up or down motion to raise or lower the basket by magnetic attraction between the handle and the basket through the side wall.
